(19) United States
(12) Patent Application Publication
(10) Pub. No.: US 2024/0010569 A1
(43) Pub. Date: Jan. 11, 2024

(54) THERMALLY STABLE THERMAL BARRIER COATINGS THAT EXHIBIT IMPROVED THERMAL CONDUCTIVITY AND EROSION RESISTANCE

(71) Applicant: Oerlikon Metco (US) Inc., Westbury, NY (US)

(72) Inventor: Timothy Tadros SHAROBEM, Westbury, NY (US)

(21) Appl. No.: 18/260,095

(22) PCT Filed: Jan. 4, 2022
(86) PCT No.: PCT/US2022/011134

§ 371 Date: Jun. 30, 2023

Related U.S. Application Data
(60) Provisional application No. 63/134,023, filed on Jan. 5, 2021.

(51) Int. Cl. C04B 35/488; C04B 35/622; C23C 4/11

(52) U.S. Cl. CPC C04B 35/488; C04B 35/62222; C23C 4/11; C04B 2235/3246; C04B 2235/3225; C04B 2235/9607; F01D 5/288

(57) ABSTRACT

A thermal spray material that exhibits improved thermal conductivity and solid particle erosion resistance is provided for thermal barrier coatings. The thermal spray material forms a thermally stable coating when thermally sprayed. The coating includes at least one phase that exhibits improved thermal conductivity and at least one phase that exhibits improved solid particle erosion resistance.

### CROSS-REFERENCE TO RELATED APPLICATION

This application claims the benefit and priority of U.S. Provisional Application No. 63/134,023 filed Jan. 5, 2021, the disclosure of which is expressly incorporated by reference herein in its entirety.

### BACKGROUND OF THE INVENTION

### 1. Field of the Disclosure

Example embodiments generally relate to a thermal spray material that forms a thermally stable coating composition when thermally sprayed. In example embodiments, the coating composition exhibits improved thermal conductivity and solid particle erosion resistance for thermal barrier coatings (TBCs). In particular, example embodiments relate to a thermal spray material that includes at least one erosion resistant component and at least one thermal conductivity component and methods for manufacturing and using the same.

### 2. Background Information

Thermal barrier coatings (TBCs) are used in several applications, including gas turbine engines, automotive industry, drilling applications in oil and gas industry, steel industry or agricultural applications. TBCs are applied on components such as combustors, high-pressure turbine blades, vanes, shrouds, and the like. Applying TBCs increases the operating temperature of hot gas path components which can result in higher energy output and improved engine efficiencies. The thermal insulation provided by TBCs enables components coated by a TBC to survive at higher operating temperatures, increases component durability and improves engine reliability. Significant advances in high temperature capabilities have been achieved, and typical yttria-stabilized zirconia (YSZ) may be used for thermal insulation in TBC systems. Coatings with 7 to 8 weight percent yttria added to zirconia provide thermal shock resistance due to its metastable transformation phase.

### SUMMARY

Example embodiments of the present disclosure relate to a powder that forms a thermal barrier coating when thermally sprayed. In one embodiment, the powder is a ceramic powder. Ceramic powder is advantageous due to its resistance to high temperatures reaching above 1000° C., but the generally higher hardness of this material may also lead to wear damage on, e.g., the nickel superalloy-based turbine blades (turbine section of aerospace engines or gas).

Severe wear damage may arise from inefficient cutting processes, leading to excessive friction-heating of blade materials under severe rubbing contact conditions in a turbine and/or if the thermally sprayed abradable coating is too hard. Examples of damage mechanisms to the blades include bulk plastic deformation and fracture, oxidation of material arising from frictional heating, and cracking of the material due to extreme cutting forces.

Thermal barrier coatings (TBCs) may improve the thermal insulation and erosion resistance properties of a coated component and may maintain these properties over the service life of the component by reducing sintering due to the use of ceramic powder. The thermal spray material for TBCs of the present disclosure differs from typical TBCs due to the multiphase nature of the coatings.

Within the present disclosure, the disclosed examples and claims, the term “phase” refers to attributes of each component in the thermal spray material.

Example embodiments of the present disclosure relate to a thermal spray material that includes at least one erosion resistant phase and at least one thermal conductivity phase. In embodiments, the crystallographic phase of either the thermal conductivity phase or the erosion resistant phase is a tetragonal phase. The erosion resistant phase and the thermal conductivity phase have been found to be thermally stable as demonstrated by being in nearly identical proportions after more than 300 hours of exposure to high temperatures of at least 1250° C. The erosion resistant phase is in a range of 60-80 wt % and the thermal conductivity phase is in a range of 20-40 wt % after 300 hours of exposure to high temperatures. Thus, the ratio of the erosion resistant phase to the thermal conductivity phase is about 2:1. In a preferred embodiment, the erosion resistant phase is about 70 wt % and the thermal conductivity phase is about 30 wt % after 300 hours of exposure to high temperatures. Thus, the ratio of the erosion resistant phase to the thermal conductivity phase is about 7:3. The multiphase structure of the components in the thermal barrier coating of the present disclosure provides improved erosion and thermal conductivity properties as compared to typical TBCs that contain only one of these phases.

In example embodiments, the at least one erosion resistant phase includes a partially stabilized zirconium oxide that includes primary stabilizers, such as ytterbium oxide and/or dysprosium oxide. In embodiments, the at least one erosion resistant phase includes a ytterbium-oxide stabilized zirconium oxide that includes 84-86 wt % ZrO₂ and 14-16 wt % Yb₂O₃. In other embodiments, the at least one erosion resistant phase includes a ytterbium-oxide stabilized zirconium oxide that includes 82-86 wt % ZrO₂ and 14-18 wt % Yb₂O₃.

In embodiments, the amount of the primary stabilizers in the erosion resistant phase is in a range of 0.1-6.0 mol %. In other embodiments, the amount of the primary stabilizers in the erosion resistant phase is in a range of 5.0-6.0 mol %.

In example embodiments, the at least one lower thermal conductivity phase includes a partially or a fully stabilized zirconia (or zirconates) that includes stabilizer oxides. In embodiments, the at least one lower thermal conductivity phase includes a cubic-zirconium oxide that includes 78-81 wt % ZrO₂, 9-10 wt % Y₂O₃, 5-6 wt % Gd₂O₃, and 5-6 wt/o Yb₂O₃. In other embodiments, the at least one lower thermal conductivity phase includes a dysprosium-oxide stabilized zirconium oxide that includes 88-92 wt % ZrO₂ and 9-11 wt % Dy₂O₃.

In embodiments, the stabilizer oxides can be one or more of the following oxides: yttrium, gadolinium, dysprosium, or ytterbium. In embodiments, the total amount of the stabilizer oxides in the thermal conductivity phase is in a range of 3-35 mol %. In other embodiments, the total amount of the stabilizer oxides in the thermal conductivity phase is in a range of 3-10 mol %.

In non-limiting embodiments, the thermal spray material includes a high erosion resistant material at a concentration in a range of 50-90 wt %. In embodiments, the thermal spray material includes a high erosion resistant material at a concentration in a range of 60-80 wt %. In other embodiments, the thermal spray material includes a high erosion resistant material at a concentration in a range of 68-72 wt %. In a preferred embodiment, the thermal spray material includes a high erosion resistant material at a concentration of about 70 wt %.

In non-limiting embodiments, the at least one erosion resistant phase and the at least one low thermal conductivity phase are present in the thermally stable coating material as a composite, a blend, or a cladded powder. In other embodiments, the blend or cladded powder provides improved coating performance, particularly erosion resistance.

In non-limiting embodiments, a method for manufacturing a thermally stable coating composition includes combining at least one erosion resistant phase with at least one low thermal conductivity phase to obtain a thermal spray material, as a composite, blend, or clad. Then, plasma spraying the thermal spray material to obtain the thermally stable coating material.

In other embodiments, the at least one erosion resistant phase and the at least one low thermal conductivity phase are not alloyed together prior to plasma spraying. In embodiments, the method for manufacturing the thermally stable coating composition provides the advantage of maintaining a coating with improved erosion resistance.

The resultant thermally stable coating material of the present disclosure provides a lower thermal conductivity and a comparable or greater solid particle erosion resistance as compared to typical yttria-stabilized zirconia (YSZ) coatings having 7 to 8 weight percent yttria added to zirconia with similar coating microstructure. Also, the resultant thermally stable coating material of the present disclosure provides thermal stability as shown by the volume fractions of the phase present in the coating being nearly identical after a long heat treatment/high temperature exposure of at least 1250° C.

### BRIEF DESCRIPTION OF THE DRAWINGS

The present disclosure is further described in the detailed description which follows, in reference to the noted plurality of drawings, by way of non-limiting examples of preferred embodiments of the present disclosure.

FIG. 1 illustrates a multiphase coating layer applied onto a substrate, according to various embodiments.

FIG. 2A is a scanning electron microscope (SEM) image showing a thermal spray material, according to an embodiment of the present disclosure.

FIG. 2B is a SEM image showing a thermally sprayed coating applied by atmospheric plasma spraying (APS), according to an embodiment of the present disclosure.

FIG. 3A is a SEM image showing a thermal spray material, according to an embodiment of the present disclosure.

FIG. 3B is a SEM image showing a lower conductivity phase of a thermally sprayed coating applied by APS, according to an embodiment of the present disclosure.

FIG. 3C is a SEM image showing an erosion resistant phase of a thermally sprayed coating applied by APS, according to an embodiment of the present disclosure.

### DETAILED DESCRIPTION

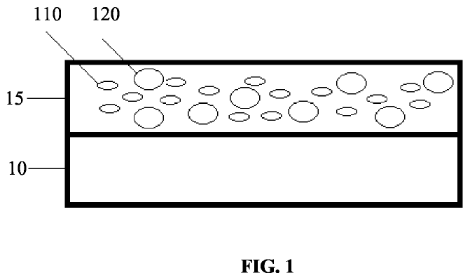

In FIG. 1, the multiphase coating layer 15 includes at least one erosion resistant phase 110 and at least one thermal conductivity phase 120. The term “phase” refers to attributes of each component in the thermal spray material prior to plasma spraying the thermal spray material to obtain the multiphase coating layer 15. The multiphase coating layer 15 is applied onto a substrate layer 10 (e.g., metal or ceramic).

In one embodiment, the erosion resistant phase 110 includes a partially stabilized zirconium oxide that includes primary stabilizers, such as ytterbium oxide and/or dysprosium oxide in an amount ranging from 0.1-6.0 mol %.

In one embodiment, the low thermal conductivity phase 120 includes a partially or a fully stabilized zirconia (or zirconates) that includes stabilizer oxides, including yttrium, gadolinium, dysprosium, and/or ytterbium. In embodiments, the total amount of the stabilizer oxides in the thermal conductivity phase is in a range of 3-35 mol %.

A thermal spray material can be manufactured by blending or cladding the at least one erosion resistant phase 110 and the at least one thermal conductivity phase 120. A multiphase coating layer 15 is formed by plasma spraying the thermal spray material onto a substrate 10.

### EXAMPLES

### Example 1

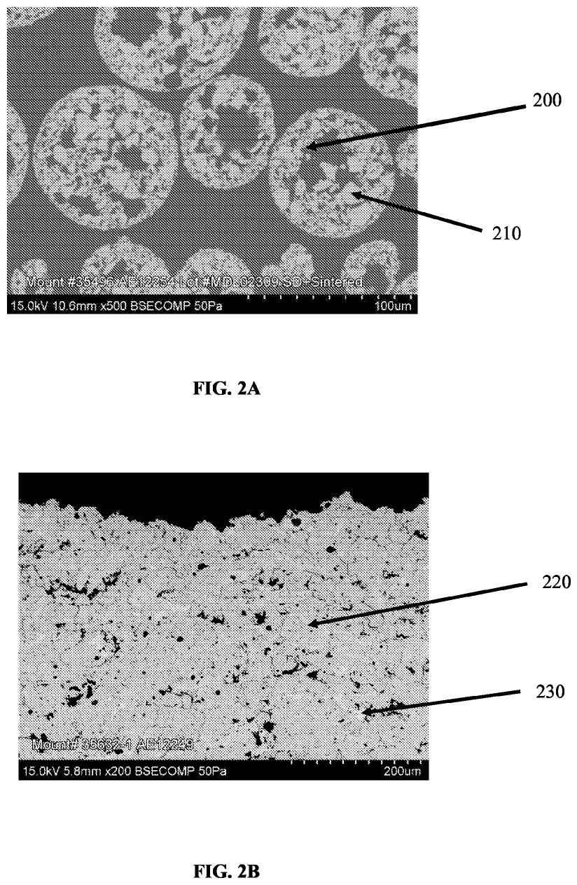

A thermal spray material according to a preferred embodiment of the present disclosure was produced by blending component (A) 210 having erosion resistance and component (B) 200 having thermal conductivity. The resulting microstructure of the thermal spray material is shown in FIG. 2A. The chemical composition of component (A) 210 was as follows: 93-96 mol % ZrO₂ and 4-7 mol % Yb₂O₃ (or 82-86 wt % ZrO₂ and 14-18 wt % Yb₂O₃). The chemical composition of component (B) 200 was as follows: 88-93 mol % ZrO₂, 1-3 mol % Yb₂O₃, 5-6 mol % Y₂O₃, and 1-3 mol % Gd₂O₃ (or 78-81 wt % ZrO₂, 5-6 wt % Yb₂O₃, 9-10 wt % Y₂O₃, and 5-6 wt % Gd₂O₃).

Then, the thermal spray material was thermally sprayed by Atmospheric Plasma Spraying (APS) to obtain the thermally stable multiphase coating material. The resulting microstructure of the thermally stable multiphase coating material is shown in FIG. 2B.

FIG. 2B shows a SEM image of a thermally stable multiphase coating material that includes at least two phases: (1) a thermal conductivity phase 230, and (2) an erosion resistant phase 220. The thermal conductivity phase 230 constituted 30 wt % of the total thermally stable multiphase coating material. The chemical composition of the thermal conductivity phase 230 was a cubic-zirconium oxide that included 78-81 wt % ZrO₂, 9-10 wt % Y₂O₃, 5-6 wt % Gd₂O₃, and 5-6 wt % Yb₂O₃.

The erosion resistant phase 220 was 70 wt % of the total thermal stable multiphase coating material. The chemical composition of the erosion resistant phase 220 constituted an ytterbium-oxide stabilized zirconium oxide that included 84-86 wt % ZrO₂ and 14-16 wt % Yb₂O₃.

The chemical composition of the combination of both the thermal conductivity phase 230 and the erosion resistant phase 220 was as follows: 91-94.5 mol % ZrO₂, 4-5 mol % Yb₂O₃, 1-3 mol % Y₂O₃, and 0.5-1.0 mol % Gd₂O₃ (or 81-83 wt % ZrO₂, 12-14 wt % Yb₂O₃, 2-4 wt % Y₂O₃, and 2-4 wt % Gd₂O₃).

The thermal conductivity of individual and combined phases were determined by comparing coatings with comparable porosity. The results are shown in Table 1.

TABLE 1

| | Normalized Thermal |
|---|---|
| Coating | Conductivity at 25° C. |
| Component A | 1.0 |
| Component B | 0.8 |
| 70% Component A and | 0.75 |
| 30% Component B | |

The erosion resistance of individual and combined phases were determined by comparing coatings with comparable porosity. The results are shown in Table 2.

TABLE 2

| | Normalized Solid Erosion |
|---|---|
| Coating | Resistance |
| Component A | 1.0 |
| Component B | 0.25 |
| 70% Component A and | 0.45 |
| 30% Component B | |

### Example 2

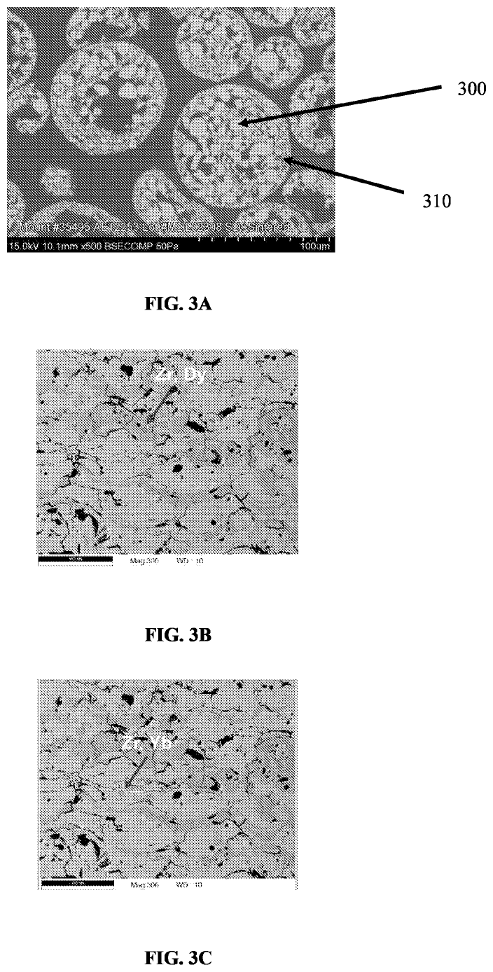

A thermal spray material according to another preferred embodiment of the present disclosure was produced by blending component (A) 300 having erosion resistance and component (B) 310 having thermal conductivity. The resulting microstructure of the thermal spray material is shown in FIG. 3A. The chemical composition of component (A) 300 was as follows: 93-96 mol % ZrO₂ and 4-7 mol % Yb₂O₃ (or 82-86 wt % ZrO₂ and 14-18 wt % Yb₂O₃). The chemical composition of component (B) 310 was as follows: 95-98 mol % ZrO₂ and 2-5 mol % Dy₂O₃ (or 88-92 wt % ZrO₂ and 8-12 wt % Dy₂O₃).

Then, the thermal spray material was thermally sprayed by APS to obtain the thermally stable multiphase coating material. The resulting microstructure of the thermal conductivity phase in the thermally stable multiphase coating material is shown in FIG. 3B. The resulting microstructure of the erosion resistance layer in the thermally stable multiphase coating material is shown in FIG. 3C.

FIG. 3B shows a SEM image of a thermal conductivity phase in the thermally stable multiphase coating material that included 88-92 wt % ZrO₂ and 9-11 wt % Dy₂O₃. The thermal conductivity phase was 30 wt % of the total thermal stable multiphase coating material. The chemical composition of the thermal conductivity phase in the thermal stable multiphase coating material was a dysprosium-oxide stabilized zirconium oxide that included 88-92 wt % ZrO₂ and 9-11 wt % Dy₂O₃.

FIG. 3C shows a SEM image of an erosion resistance phase in the thermally stable multiphase coating material. The erosion resistant phase was 70 wt % of the total thermal stable multiphase coating material. The chemical composition of the erosion resistant phase in the thermal stable multiphase coating material was an ytterbium-oxide stabilized zirconium oxide that included 82-86 wt % ZrO₂ and 14-18 wt % Yb₂O₃.

The chemical composition of the combination of both the thermal conductivity phase and the erosion resistant phase was as follows: 91-98 mol % ZrO₂, 2-6 mol % Yb₂03, and 0.3-3 mol % DyO₃ (or 80-92 wt % ZrO₂, 7-14 wt % Yb₂O₃, and 1-6 wt % Dy₂O₃).

The thermal conductivity of individual and combined phases were determined by comparing coatings with comparable porosity. The results are shown in Table 3.

TABLE 3

| | Normalized Thermal |
|---|---|
| Coating | Conductivity at 25° C. |
| Component A | 1.0 |
| Component B | 0.95 |
| 70% Component A and | 0.80 |
| 30% Component B | |

The erosion resistance of individual and combined phases were determined by comparing coatings with comparable porosity. The results are shown in Table 4.

TABLE 4

| | Normalized Solid Erosion |
|---|---|
| Coating | Resistance |
| Component A | 1.0 |
| Component B | 0.90 |
| 70% Component A and | 0.95 |
| 30% Component B | |

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A thermal spray material for thermal barrier coatings, comprising:
component (A) having erosion resistance; and
component (B) having thermal conductivity.

2. The thermal spray material according to claim 1, wherein the component (A) comprises a partially stabilized zirconium oxide.

3. The thermal spray material according to claim 2, wherein the partially stabilized zirconium oxide comprises a primary stabilizer in an amount of 0.1-7 mol %, and wherein the primary stabilizer is an ytterbium oxide and/or a dysprosium oxide.

4. The thermal spray material according to claim 3, wherein the partially stabilized zirconium oxide comprises a primary stabilizer in an amount of 4-7 mol %, and wherein the primary stabilizer is an ytterbium oxide and/or a dysprosium oxide.

5. The thermal spray material according to claim 3, wherein the partially or the fully stabilized zirconia comprises a stabilizer oxide, and wherein the stabilizer oxide comprises 4-7 mol % ytterbium oxide.

6. The thermal spray material according to claim 1, wherein the component (B) comprises a partially or a fully stabilized zirconia.

7. The thermal spray material according to claim 6, wherein the partially or the fully stabilized zirconia comprises a stabilizer oxide in an amount of 3-35 mol %, and wherein the stabilizer oxide is selected from the group consisting of yttrium oxide, gadolinium oxide, dysprosium oxide, and ytterbium oxide.

8. The thermal spray material according to claim 6, wherein the partially or the fully stabilized zirconia comprises a stabilizer oxide, and wherein the stabilizer oxide comprises 5-6 mol % yttrium oxide and 1-3 mol % gadolinium oxide.

9. The thermal spray material according to claim 6, wherein the partially or the fully stabilized zirconia comprises a stabilizer oxide, and wherein the stabilizer oxide comprises 2-5 mol % dysprosium oxide.

10. A method for manufacturing a thermally stable multiphase coating material for thermal barrier coatings comprising:
blending component (A) having erosion resistance with component (B) having thermal conductivity to obtain a thermal spray material; and
plasma spraying the thermal spray material to obtain the thermally stable multiphase coating material comprising at least one erosion resistant phase and at least one thermal conductivity phase.

11. The method according to claim 10, wherein the component (A) and the component (B) are not alloyed together prior to plasma spraying.

12. A thermally stable multiphase coating material obtained from the thermal spray material according to claim 1, comprising:
at least one erosion resistance phase; and
at least one thermal conductivity phase.

13. The thermal stable multiphase coating material according to claim 12, wherein the at least one erosion resistance phase is in a range of 50-90 wt % of the thermal stable multiphase coating material and the at least one thermal conductivity phase is in a range of 10-50 wt % of the thermal stable multiphase coating material.

14. The thermal stable multiphase coating material according to claim 13, wherein the at least one erosion resistance phase is in a range of 60-80 wt % of the thermal stable multiphase coating material and the at least one thermal conductivity phase is in a range of 20-40 wt % of the thermal stable multiphase coating material.

15. The thermal stable multiphase coating material according to claim 13, wherein the at least one erosion resistance phase is in a range of 65-75 wt % of the thermal stable multiphase coating material and the at least one thermal conductivity phase is in a range of 25-35 wt % of the thermal stable multiphase coating material.

16. The thermal stable multiphase coating material according to claim 12, wherein the at least one erosion resistance phase comprises an ytterbium-oxide stabilized zirconium oxide comprising 84-86 wt % ZrO₂ and 14-16 wt % Yb₂O₃, and wherein the at least one thermal conductivity phase comprises a cubic-zirconium oxide comprising 78-81 wt % ZrO₂, 9-10 wt % Y₂O₃, 5-6 wt % Gd₂O₃, and 5-6 wt % Yb₂O₃.

17. The thermal stable multiphase coating material according to claim 12, wherein the at least one erosion resistance phase comprises an ytterbium-oxide stabilized zirconium oxide comprising 82-86 wt % ZrO₂ and 14-18 wt % Yb₂O₃, and wherein the at least one thermal conductivity phase comprises a dysprosium-oxide stabilized zirconium oxide comprising 88-92 wt % ZrO₂ and 9-11 wt % Dy₂O₃.
